(19) United States
(12) Patent Application Publication
(10) Pub. No.: US 2006/0013969 A1
(43) Pub. Date: Jan. 19, 2006

(54) Artificial floral assembly

(76) Inventor: Maureen D. M. Haupt, Santa Monica, CA (US)

Correspondence Address: Roberta M. Fay, P.O. Box 11355, Marina del Rey, CA, 90295-7355, US

(21) Appl. No.: 10/892,943

(22) Filed: Jul. 16, 2004

(51) Int. Cl. A01N 3/00

(52) U.S. Cl. 428/17; 428/21

(57) ABSTRACT

The artificial floral assembly comprises a stem backbone, a flower bloom, and a leaf structure as well as an optional stem interface. The stem backbone may have wire, plastic material, duct tape, caulking, and fabric. The flower bloom may have wire rings joined together at a center point, strands of wire dangling from the center point, and fabric covering the wire rings. The process for making the stem backbone may involve wrapping a flower bloom and a leaf around a section of a wire segment, then wrapping plastic material, tape, adhesive, and fabric along the entire wire segment. The process for making the flower bloom may involve forming a plurality of wire rings which are positioned around a center point, covering each ring with fabric, and painting the fabric.

### BACKGROUND OF THE INVENTION

Artificial flowers and decorations based on artificial flowers and plant-like structures are commonplace. Consequently, there is an ongoing need for artificial flowers which are long lasting, durable, and constructed from inexpensive, environmentally safe materials. Also, there is a need for resilient stems, petals, and leaf structures that are easy to work with and easy to assemble in a variety of floral composites and mixtures.

Problems and difficulties occur with conventional practices to create artificial flowers. Typically, silk, plastic, or a woven polyester fabric has been used as the material for duplicating leaves or petals in flower construction. Silk is extremely light and requires substantial support to maintain a desired shape of petal or leaf. Plastic materials typically require costly molds and forms so that the plastic may assume various surface textures and simulate the leaf or petal. Woven polyester fabric also has been molded and then sized with a stiffening agent so that the resulting fabric retains an appropriate shape. Generally, any of these materials result in surface textures that require additional painstaking painting and decorative steps.

Alternatively, dried flowers have been used; they are obtained by preserving natural flowers. Typical preservation methods include freeze drying, drying with a desiccant such as silica sand, plasticizing, dipping in paint, and treating with chemicals such as glycerine. U.S. Pat. No. 4,943,455 is directed to a structure in which each petal component is formed from a rubberized material or elastic construction. The edge marginal regions of each of the components internally contracts so as to provide a wavy or terminating edge which is meant to resemble a leaf or a petal. Two other patents, U.S. Pat. Nos. 5,108,800 and 5,240,526, are directed toward a different method of making artificial flowers. In these cases, the tips of the petals are heated to a temperature sufficient to melt the fabric in the region of the tips while the petal in other areas is protected from the heat. With this process, a shriveled, dried-up appearance is imparted to the artificial flower.

### SUMMARY OF THE INVENTION

The artificial floral assembly comprises a stem backbone, a flower bloom, and a leaf structure as well as an optional stem interface. The stem backbone may have wire, plastic material, duct tape, caulking, and fabric. The flower bloom may have wire rings joined together at a center point, fabric covering the wire rings, and strands of wire dangling from the center point. The leaf structure may have fabric, adhesive material, and wires. The process for making the stem backbone may involve wrapping a flower bloom and a leaf around a section of a wire segment, then wrapping plastic material, tape, adhesive, and fabric along the entire wire segment. The process for making the flower bloom may involve forming a plurality of wire rings which are positioned around a center point, covering each ring with fabric, and painting the fabric.

### BRIEF DESCRIPTION OF THE DRAWINGS

FIG. 1 shows a side plan view of the completed artificial floral assembly.

FIG. 2 shows a side plan view of three wires (used to create the wire frame).

FIG. 3 shows a perspective view of a sheet of fabric with the wires positioned along the sheet and the top layer of fabric partially folded over the bottom layer of fabric.

FIG. 4 shows a side plan view of three leaves joined together by twisted wires.

FIG. 5 shows five loops of wire twisted and tied together, forming one set of five rings.

FIG. 6 shows three sets of rings, forming a total of fifteen rings; each set of wire rings containing five loops of wire (as shown in FIG. 5).

FIG. 7 shows the fifteen rings spread out and placed strategically around a center point; one of the outermost rings has footsox material covering the individual ring.

FIG. 8 shows a side plan view of the rings with the outermost rings covered with footsox material.

FIG. 9 shows a top plan view of the rings with most of the outermost rings covered with footsox material.

FIG. 10 shows a side plan view of the same ring structure shown in FIG. 9.

FIG. 11 shows a perspective view of a completed flower bloom (with the dangling strands of wire and with the fifteen rings covered with footsox material).

FIG. 12 shows a bottom plan view of a completed flower bloom.

FIG. 13 shows a top plan view of a completed flower bloom.

FIG. 14 shows a side plan view of a stem wire with chenille fabric wrapping.

FIG. 15 shows a cross-sectional view of a stem backbone with the multiple layers covering the fence wire.

FIG. 16 shows a perspective view of a stem interface.

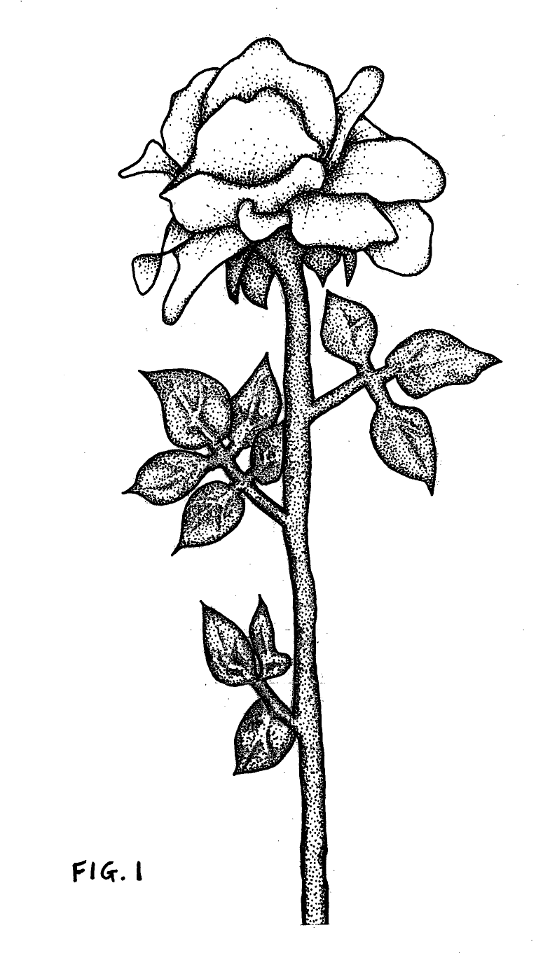

Similar reference characters denote corresponding features consistently throughout the attached drawings. The figures are not drawn to scale.

### DETAILED DESCRIPTION OF THE INVENTION

In general, the artificial floral assembly can be considered a construct of five subassemblies: (1) frame for individual leaves, (2) leaf structure, (3) flower bloom, (4) stem backbone of floral assembly, and (5) stem interface. Each subassembly is constructed separately and independently of the other subassemblies. Depending on the application, individual subassemblies may or may not be used. In any given artificial floral assembly, not all five subassemblies are required.

An aspect of the invention involves building many different combinations of flowers, leaves, stems, and branches. As constructed, the overall assembly and the individual components are not limited to specific sizes, shapes, or color combinations. The flower bloom in particular is easy to adjust and modify. Another aspect of the invention is the ability to add to existing structures or subtract from existing structures.

In addition, the completed structure does not show dust, dirt, or ordinary wear easily. Another aspect is that the completed structure is not susceptible to most typical household solvents and fluids. Food, drink, and other materials might “stain” the fabric but they will not affect the structural integrity. There is no need for regular cleaning or maintenance work. Yet, the artificial floral assembly can be washed with a stream or hose of water. If necessary, the flower bloom can be repaired with nail polish and the individual flower petals can be replaced.

Another aspect of the invention is its longevity. The stem structure will support flowers and leaves over a long time period (as much as 3 to 10 years). Individual flowers and leaves will not typically wilt, disintegrate, or fall off the stem.

Both the completed artificial floral assembly and the individual parts are not sensitive to temperature, humidity, light, darkness, altitude, or varying climates. The assembly will hold up under hot lights. It is not sensitive to sound or other extreme environmental conditions.

Another aspect of the invention is that the assembly can be squashed down, seriously wrinkled, and then resuscitated (that is, repaired to appear as an original). In particular, the wires on petals can be wrinkled/crunched. The artificial floral assembly can be transported in various containers/luggage. Consequently, the invention can be set up and torn down with ease. The materials are both difficult to damage and simultaneously easy to repair.

Also, the starting materials may be generally cost effective and environmentally safe. There may be minimal waste of materials; that is, each material may be utilized fully depending on the application. For example, the knot of footsox material that binds the fifteen rings together also provides the center of the flower bloom. Besides providing color, the spray paint makes footsox material much stronger than silk.

Because of these factors, the artificial floral assembly can fit into many different design showcases. In addition, it can be kept separately and sold in custom or standard assembly packages with paint and caulking material supplied either separately or integrated into the assembly packages.

### Process Steps for Creating the Artificial Floral Assembly

First subassembly: Frame for individual leaves

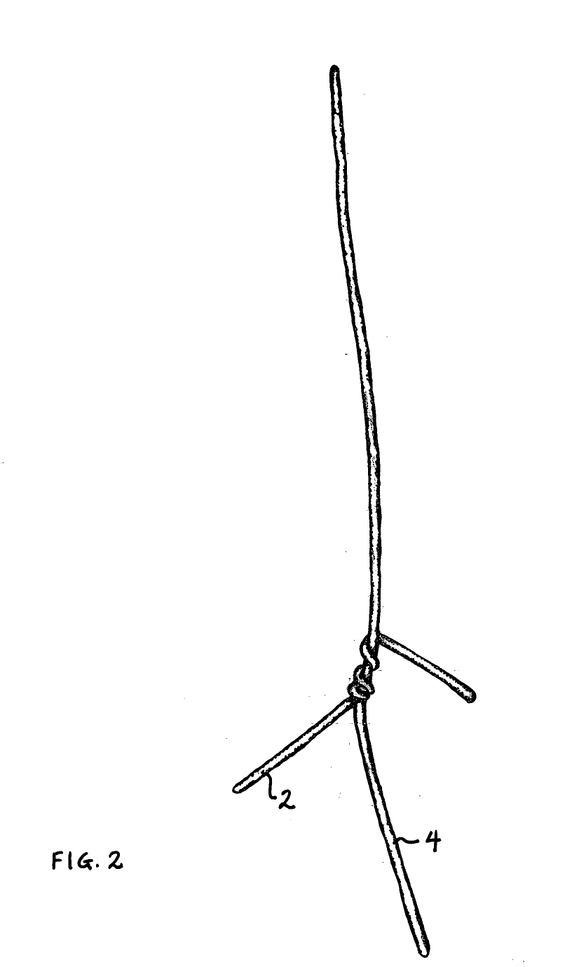

1. Create the wire frame for the leaf structure:
1. Put one 2″ wire piece 2 across another 8″ wire piece 4 toward one end (approx. 2″ from the end). Note: larger flower leaves can be created with longer wire pieces.
2. Wrap the two wire pieces tightly together several times so that they are firmly fixed together, as shown in FIG. 2.

2. Cut a strip 6 of the fabric that is approx. 60″ long, 10″ wide, and less than ⅛″ deep.

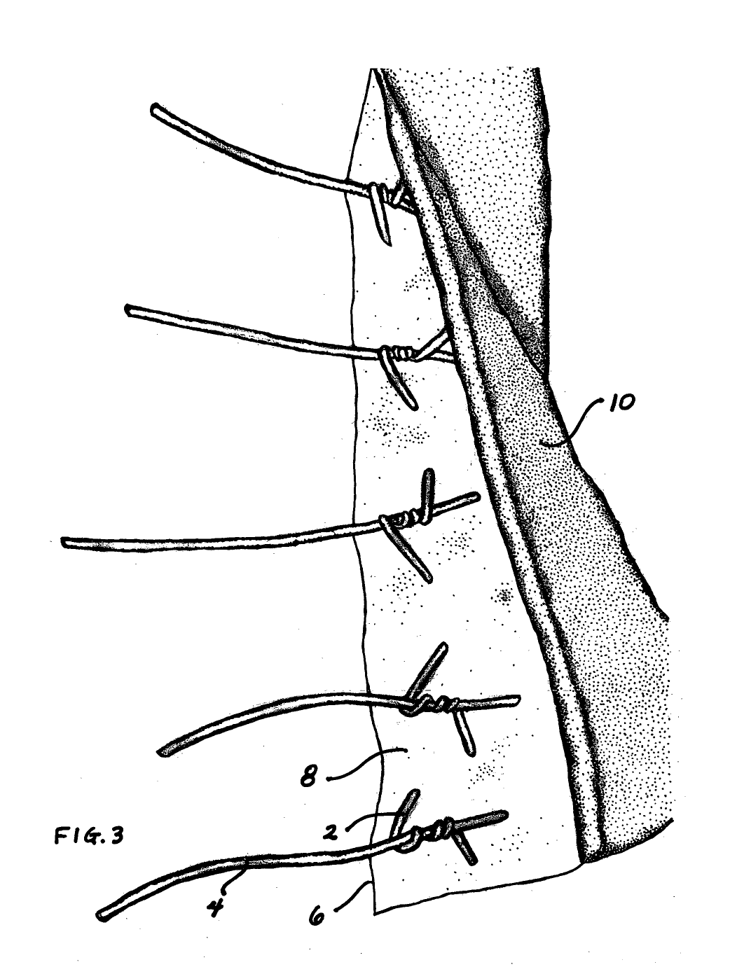

3. Stream 2′ to 4′ of caulking across the strip of fabric so that the caulking covers ½ of the available surface area 8, as shown in FIG. 3. Spread completely and evenly over ½ of the fabric strip 6 using fingers or a spatula.

4. Line the wire frames across the side 8 where the caulking material is spread out, as shown in FIG. 3. Place the frames on the caulked surface in a pattern so that at least 4″ separates the frames. For example, for a strip of fabric 26″ long and 8″ wide, 9 medium sized frames may be used. For substantially larger leaves, the entire area can be covered with caulking and a second whole strip of fabric placed on top.

5. Fold over the uncaulked side 10 of fabric onto the caulked side 8 of fabric with the wire frames laid out, as shown in FIG. 3. Press and smooth over so that the caulking is distributed evenly across the entire surface area and wire frames are sandwiched between the two sides.

6. Let set for 1 hr. to 24 hr. so that the caulking cures properly.

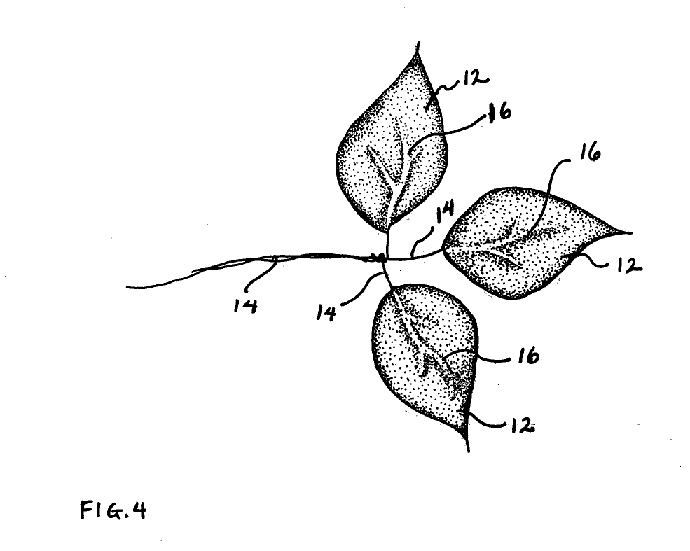

7. Cut the fabric into leaf shapes 12, which are shown in FIG. 4. Each leaf has a stem of exposed wires 14 and veins which are actually wires 16 imprinted inside the fabric material. Leaves can and should be differently shaped and sized, depending on design plans.

Second subassembly: Leaf structure

1. Place one leaf 12 in a horizontal plane and then place two leaves 12 approx. 2½″ underneath the top leaf and at a 90 degree angle from the top, so that exposed wires 14 intersect as shown in FIG. 4.

2. Twist sections of wire 14 of the three leaves together, as shown in FIG. 4.

3. Wrap black chenille stem material around exposed wire 14 so that all exposed wire 14 is covered completely. The individual black chenille stem material is approx. 6″ to 18″ long and approx. ⅛″ to ¼″ in diameter.

4. Cut thin polyester fur into thin strips that are ½″ to 1″ wide. (It is acceptable if the thin polyester fur rolls onto itself and twists into a soft bundle.)

5. Put caulking over chenille stem, covering completely with a thin layer of caulking all along the stem.

6. Wrap the polyester fur strip over and around the chenille stem completely.

7. Let set for 1 hr. to 24 hr. so that the caulking cures properly.

Third subassembly: Flower bloom

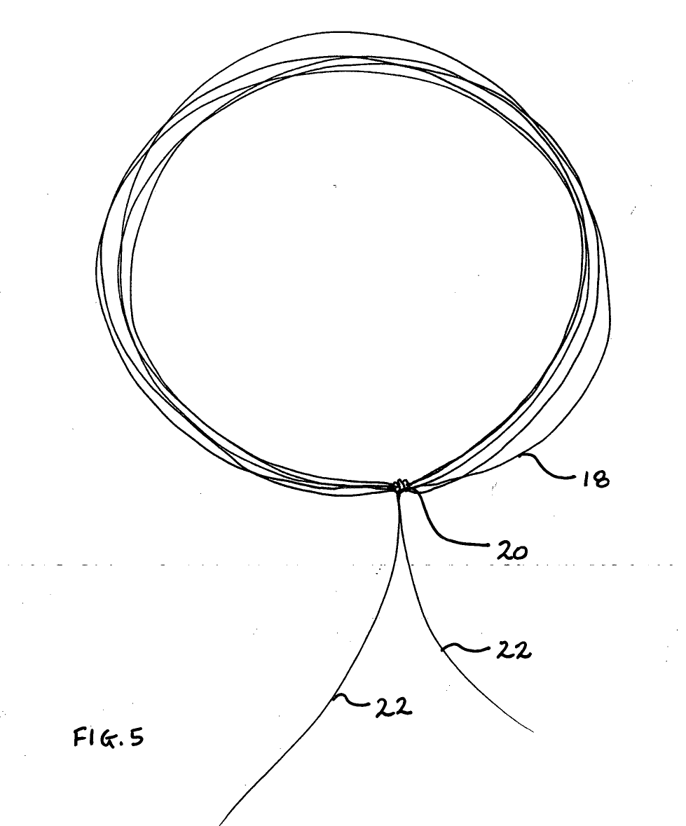

1. Take 5 loops of wire, each loop 18 approx. 8″ in diameter, as shown in FIG. 5; ends of each wire stick out from the circular loop shapes. The material and gauge of this wire may be the same as or similar to that used for the wire in the leaf structure.

2. Take wire ends from the combined 5 loops and wrap the wire ends 3 times around one area 20 of the 5 combined loops, thus forming a ring containing five loops of wire. Below the ring and the general area 20 are dangling wire strands 22, as shown in FIG. 5.

3. Repeat steps 1 and 2 twice so that there are 3 rings each containing 5 loops of wire 18 and dangling wire strands 22. (Note that it is possible to create 4 rings, each containing 5 loops of wire, instead of 3 rings, as shown in this process subassembly.)

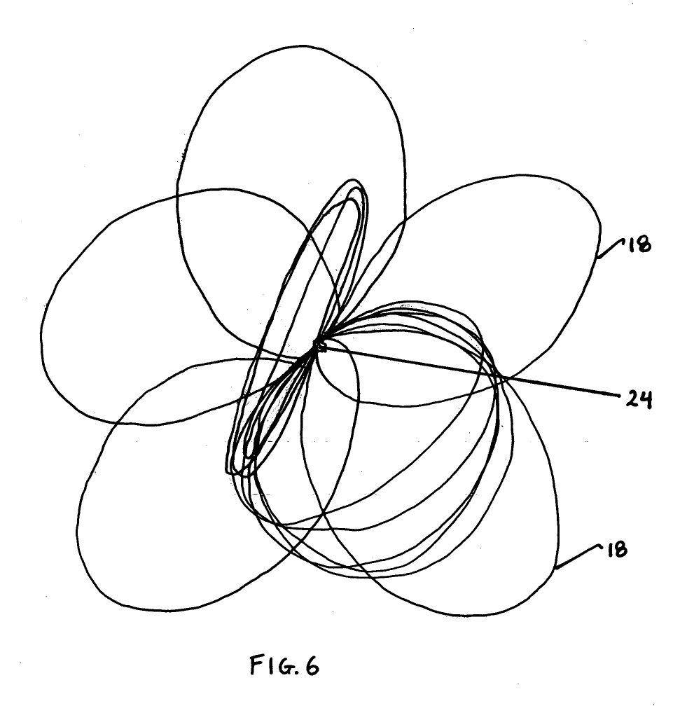

4. Connect the 3 rings together by wrapping the ends of the wire strands together tightly in a small confined area 24, as shown in FIG. 6. Since the wire loops are gathered together in this area, it is the center point or gathering point, which, in turn, becomes the center of the flower, from which the individual petals radiate outward.) The dangling wire strands 22 will hang freely below the center point 24.

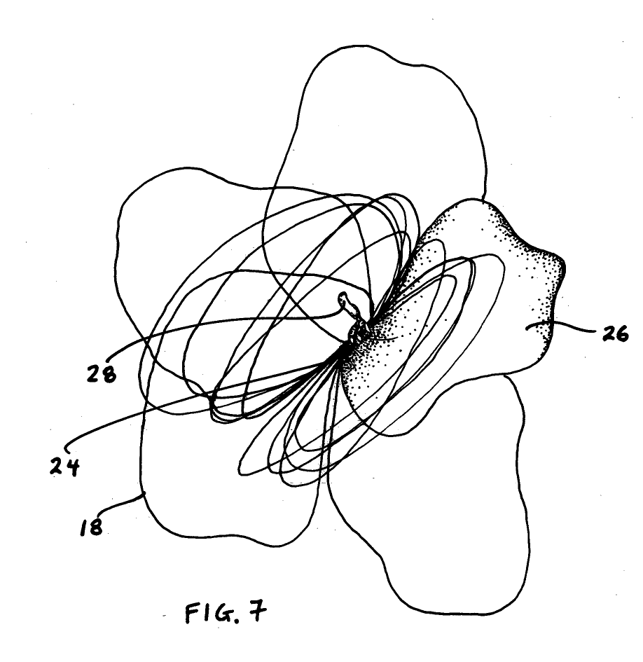

5. Separate the connected rings into three groupings, each grouping containing a set of five loops. Then, starting with the ring grouping farthest from the center point 24, separate five loops and position the individual loops into planes of varying radial degrees from the remaining groupings of loops, as shown in FIG. 6 and FIG. 7. The individual loops should fan out in varying radial layers, from almost perpendicular to almost 45 degrees from the remaining groupings of loops. Wrinkle each loop slightly.

6. Open the footsox material and turn the material inside out so that the portion that has been sewn together is on the inside. (Repeat this step for all the footsox material to be used in making flower petals.)

7. Starting with the outermost wire loop, place the footsox material 26 over and around the wire loop so that the wire loop is covered completely with footsox material, as shown in FIG. 7.

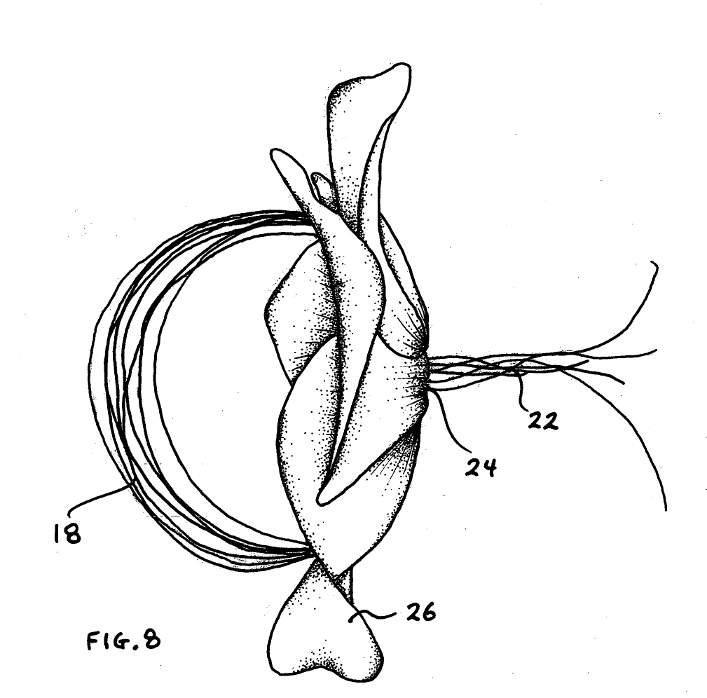

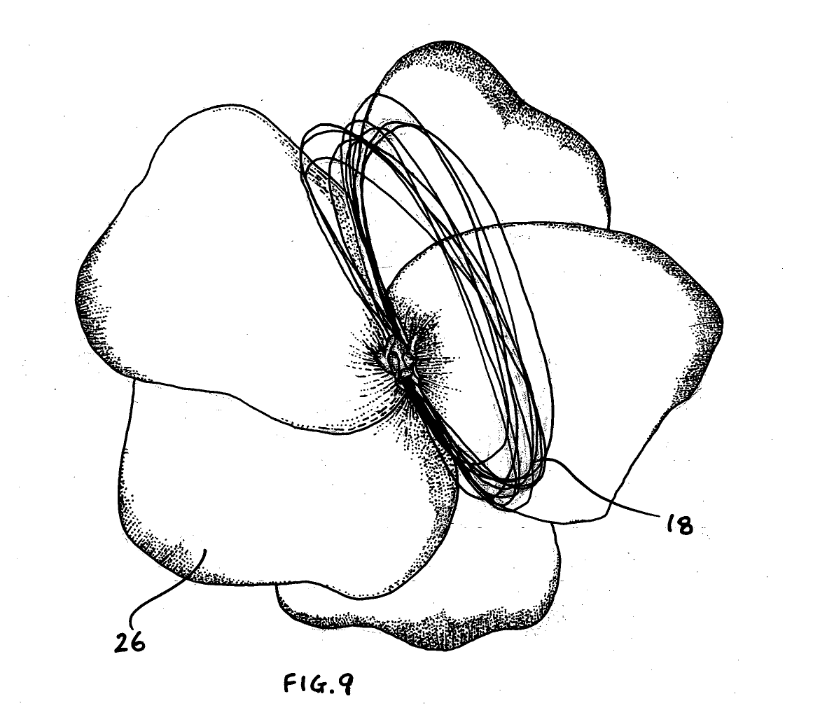

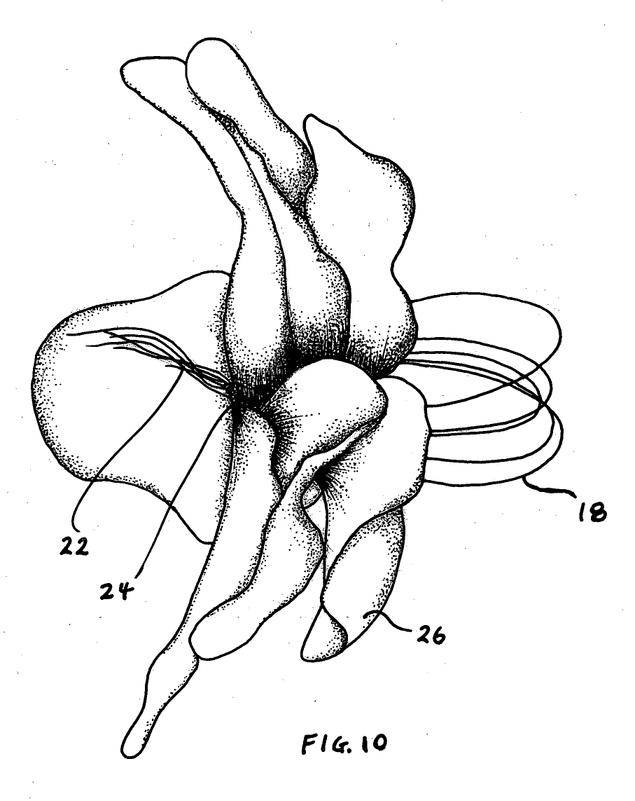

8. Wrap ends of footsox material together in central area 28, as shown in FIG. 7. Tie the ends of the footsox material (in the central area) together with a basic knot, as shown in FIG. 7. The knot 28 is located in the general area of the center point 24. FIG. 8 shows a side plan view of the rings with the outermost rings covered with footsox material. For this structure, FIG. 9 shows a top plan view and FIG. 10 shows another side plan view from a different perspective.

9. Spread out the individual wire loops in the second (intermediate) ring group and the third (innermost) ring group. The loops should fan out radially in varying planes and varying degrees, in order to resemble the structure of petals on a blooming flower.

10. For the second (intermediate) ring grouping, repeat steps 6 to 10.

11. For the third innermost ring grouping, repeat steps 6 to 10.

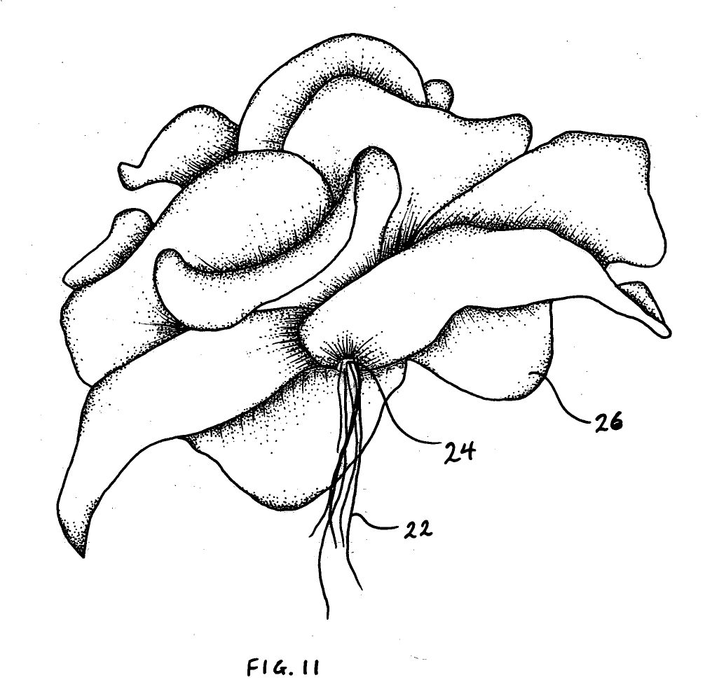

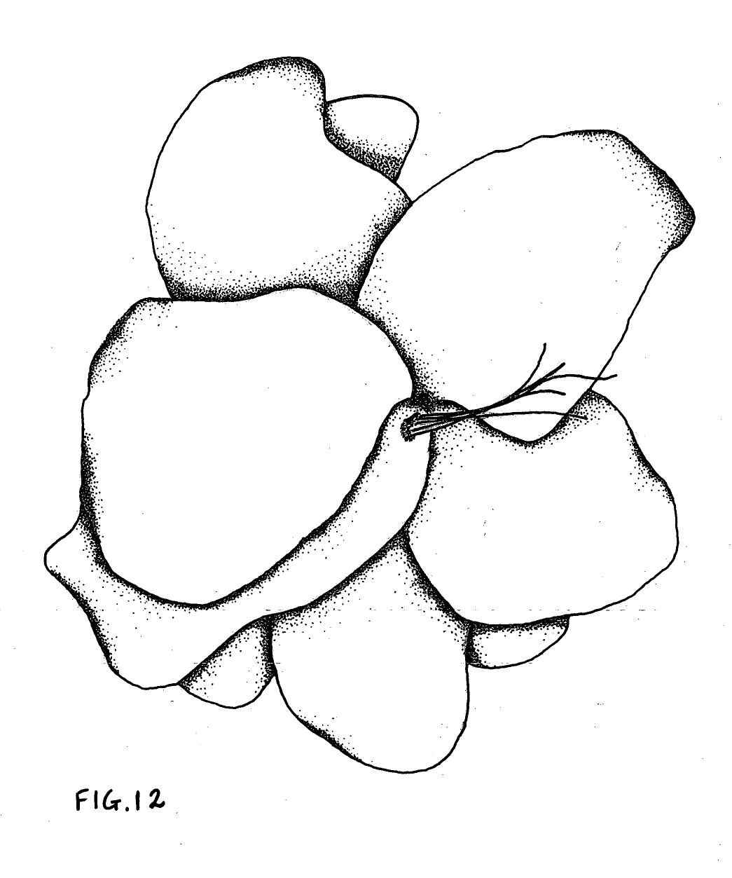

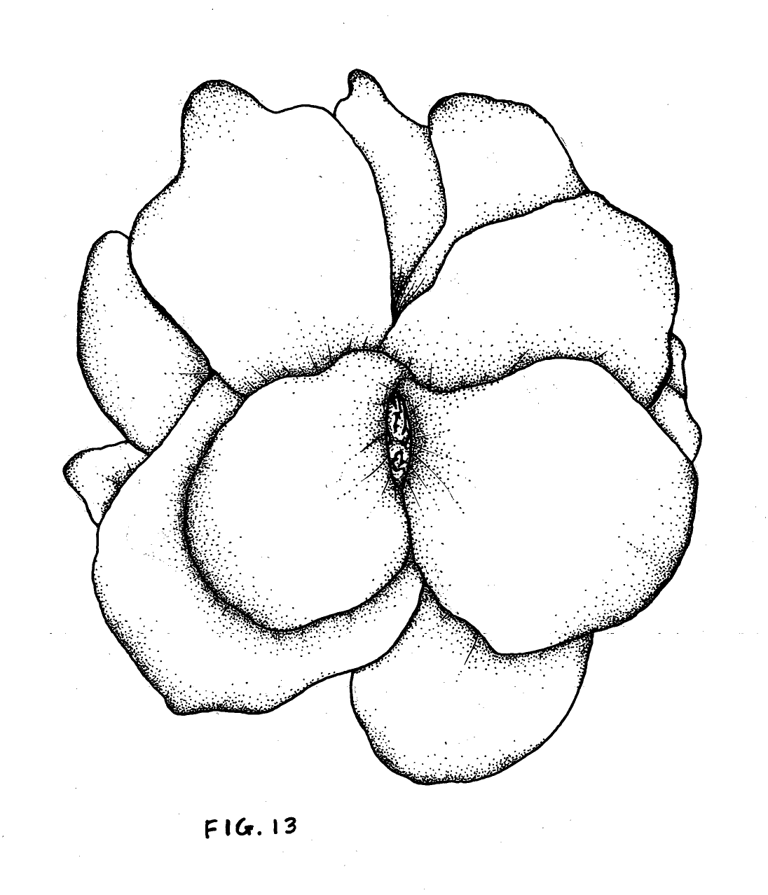

12. Arrange the loops (with the covered footsox material) in a decorative fashion in order to resemble a flower with blossoming and varying petals. In terms of the completed flower bloom, FIG. 11 shows a perspective view with the underside of the flower bloom exposed. For the same structure, FIG. 12 shows a bottom plan view, and FIG. 13 shows a top plan view.

13. Spray paint the flower petals on both the underside and topside, as well as tips and exposed wires. Spray the entire surface and underlying structure thoroughly. If appropriate, use a second complementary color of spray paint in order to create a suitable color combination.

Fourth subassembly: Stem backbone of artificial flower assembly

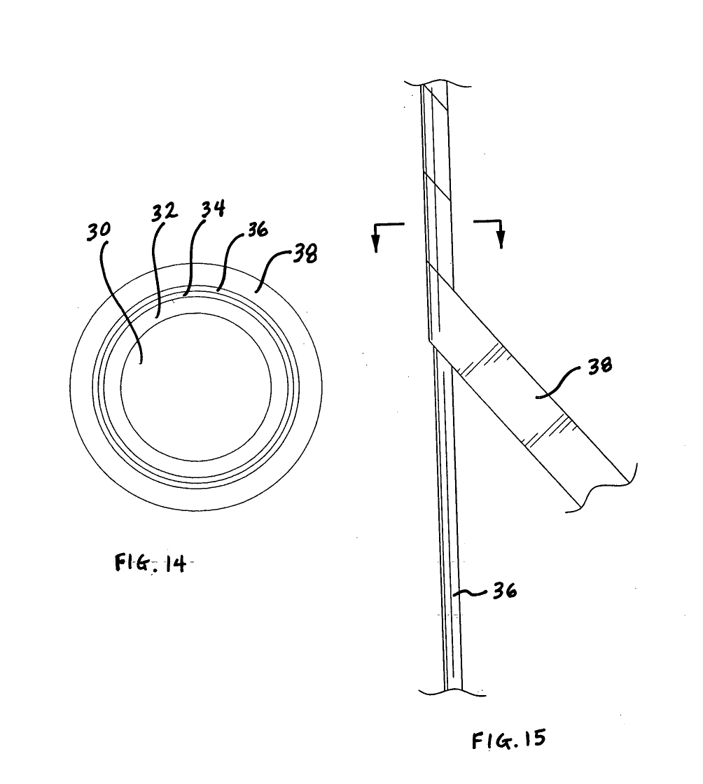

1. Cut fence wire into 3′-5′ segments. A cross-sectional view of the fence wire 30 covered with several layers is shown in FIG. 14.

2. Assemble flower blooms (obtained from third subassembly process), leaves (from the first subassembly process), and leaf structures (from second subassembly process).

3. Wrap the dangling wire strands 22 of a flower bloom tightly around one end or one location on the fence wire.

4. Wrap the exposed wire 14 of a leaf 12 around the fence wire 30 immediately below the flower bloom (that is, immediately below the flower petals on the fence wire). If appropriate, fasten the wire 14 with duct tape. Alternatively, three interconnected leaves (as shown in FIG. 4) can be wrapped around the stem below the flower bloom and then attached by applying duct tape. The duct tape (which is sometimes spelled “duck tape”) is typically a grey or silver color but almost any color will suffice.

5. Repeat steps 3 and 4 two to three times, resulting in 3 to 4 leaves below the flower bloom subassembly. Alternatively, affix several leaf combinations below the flower bloom.

6. Use duct tape to secure the wrapping on the fence wire below the flowers and leaves. Cover all the wrapped wiring along the fence wire stem with duct tape.

7. Take plastic garbage bag and knot the garbage bag material tightly at the top of the fence wire immediately below the first flower/leaf structure; secure the knot with duct tape.

8. Wind the garbage bag material as tightly as possible around all the exposed fence wire 30, thereby forming layer 32 of garbage bag material.

9. Place duct tape securely over the entire surface of the garbage bag material, thereby forming layer 34 of duct tape, as shown in the cross-sectional view of FIG. 14. If needed, in order to create an airtight seal of duct tape 34 over the garbage bag material layer 32, remove air pockets, bubbles of material, or exposed surfaces by slicing with a scissor or another sharp implement.

10. Attach the prepared leaf structure (as shown in FIG. 4) to the stem by wrapping exposed wire 14 around duct tape layer 34, and affix with additional duct tape.

11. Place caulking over the entire duct taped surface 34 forming a layer 36 of caulking as shown in the cross-sectional view of FIG. 14. Smooth the caulking over with fingers or a spatula, carefully placing caulking in any exposed cracks, crevices, or points joining leaf structures or flower petals to the underlying fence wiring.

12. Wrap the thin polyester fur 38 over the entire caulking layer 36, as shown in FIG. 15. Wrap the thin polyester fur tightly and closely, overlapping along the entire fence wire. This layer 38 is the outermost layer covering the fence wire 30, as shown in FIG. 14.

13. Let set for 1 hr. to 24 hr. so that the caulking cures properly.

Fifth subassembly: Stem interface (optional

A typical stem interface comprises a cylinder of pole material and a base. The cylinder has an outer diameter of ¾″ to 1½″ and an inner diameter of ½″ to 1″; the pole material may be fabricated plastic or welded steel or a suitable composite. The cylinder contains two ends, each end with a male connector opening (or, alternatively, a female connector opening). This cylinder is actually the spine section of the stem interface.

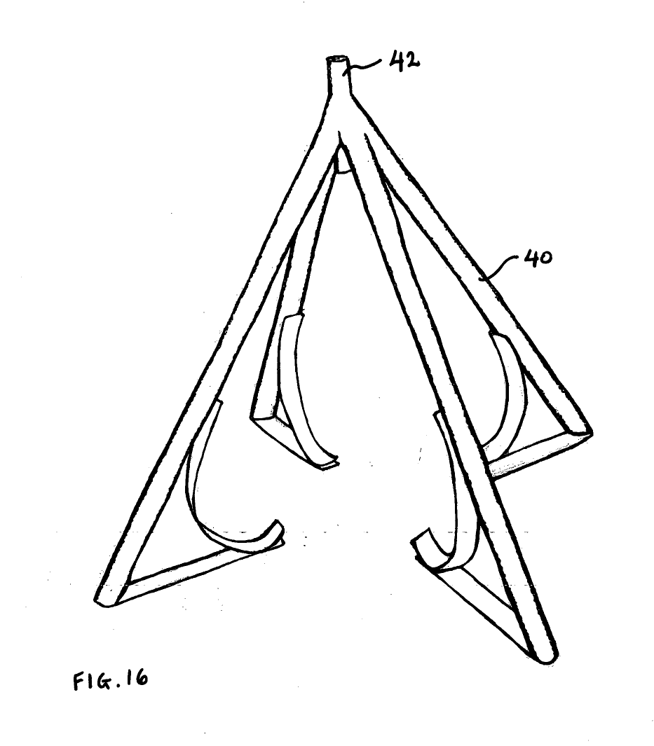

The base of the stem typically contains 3 or 4 legs 40 for support and a top opening 42 that is a female connector (or, alternatively, a male connector), as shown in FIG. 16. The base may be plastic, steel, or any suitable material that is compatible with the cylinder material. The base provides ground support or vertical support for the spine or top separate piece.

The top separate piece of cylinder comprises a female connector (or, alternatively, a male connector). The top piece is available for uniting with the spine section or the base and the top piece is available for integrating with different artificial floral assemblies. The male connector of the spine section is a cylindrical fitting which may be attached on its internal side with epoxy or an adhesive. The female connector is also a cylindrical fitting with its inside diameter slightly larger than the outside diameter of the male connector. The female connector is also attached with epoxy or an adhesive.

The constructed stem interface can be utilized to create a variety of floral assemblies. For example, different backbones of flower assemblies can be attached to the base of the stem interface and secured with an epoxy mixture. The exposed wire of flower bloom can be cut to match the size of the male connector and attached with epoxy. Likewise, the exposed wire of the leaf or leaf combination (that is, leaf subassembly) can be cut to match the size of the male connector and also attached with epoxy. The epoxy mixture is used wherever the wire is inserted into the male or female part of stem interface. Then, the base of interface is attached to the spine and secured with epoxy mixture or another suitable adhesive material.

The materials each may have specific strengths and advantages that contribute to the overall invention. For the stem backbone, the garbage bag material helps create a soft, squishy covering that approximates the touch and feel and thickness of natural plant stems. The duct tape gives both strength and plasticity to the stem. The caulking is easy to apply and easy to dispense cleanly and smoothly over different surface structures.

Because of the combination of materials (that is, the combination of garbage bag material, duct tape, and caulking), the completed stem can be bent and twisted without breaking the stem or permanently damaging the stem. Also, the combination of caulking and new chenille fabric can be used to fix or modify the stem or leaves. This combination can cover or repair virtually any kind of background or underlying material in the artificial floral assembly.

The thin polyester fur covers the interface leaves and connections between the leaves, stems, and flowers. The thin polyester fur is a chenille material, that is, a polyester cotton, furry material that stretches, is easily cut into strips of varying sizes. The strips blend together into a uniformly appearing surface with a suitable soft texture. They can also be used to give the leaves extra thickness. The preferred chenille fur is a 45% cotton, 55% polyester blend, with a green color. The chenille has a protruding pile, which actually makes the chenille soft to handle and stretchable.

With respect to the flower bloom, the wire loops can be wrinkled, crunched, pushed, pulled, and manipulated into many different sizes and shapes. The footsox material can be washed to remove any strongly colored stains. For really strong stains, spray paint can be used to “fix” or change the color. Clear nail polish can be used to fix breaks in the footsox material.

The stem interface allows for the replacement of flower blooms and different leaf structures. The stem interface can be incorporated into many different environments. It can substitute for virtually any potted plant with particularly designed stem interfaces.

Substitutions can be made for practically all the individual materials in the assembly. For example, the leaf fabric can be cotton, polyester, velvet, silk, canvas, paper, cardboard, and/or a blend of materials. Even a different shade of color can be substituted for green and a pattern can be substituted for the solid color. For the leaf subassembly, the wire is typically 18 gauge to 22 gauge galvanized wire; substitutions include different gauges and almost any wire materials, including aluminum, copper, or amalgams. For the flower bloom subassembly, the wire used for the loops may be the same or similar; that is, the same material and gauge size constraints apply (or do not apply).

The preferred caulking material is a siliconized acrylic caulk which, because of its material characteristics, allows the final structure to be bent, twisted, and reshaped. Other types of caulking, adhesives, and epoxies can be substituted but the overall structural stability and resilience may be adversely affected. While typically clear caulking is applied, other colors can be used for specific design purposes.

The black chenille stem material used in creating the leaf structure is generally known as “chenille pipe cleaners”. Possible substitutions include colored chenille stems and flexible wire of a suitable gauge. For the cotton/polyester blend chenille fabric, other chenille fabrics, such as a velvety silk, wool or cotton fabric can substitute. Even non-chenille fabrics with different colors and patterns may substitute as long as the material stretches easily without damage or breakage.

The footsox material used in creating the flower bloom is a commonplace polyester, nylon, cotton, or blend of fabrics, with a transparent color. Possible substitutes include any sewn polyester blend or nylon material with a flexible surface; the materials may be opaque or transparent and they may have many different colors.

The compressed paint spray is a spray enamel. Alternatively, it can be an oil, acrylic, or a combined oil/acrylic base. Typically, one paint mixture is used for each applied color (created with compressor and paint mixture). Depending upon design needs, any color or color combination can be used. Even a paint brush could be used to hand paint the flower blooms. For repairing flower blooms, an acrylic lacquer liquid solution such as a clear nail polish, correction fluid, or another liquid solution may be utilized.

For the backbone, any typical commercially available fence wire may be used. Typically, the wire is ¼″ to ⅜″ uncoated cable or galvanized steel that is cut into 2′ to 5′ lengths (depending on the specific artificial floral assembly). However, virtually any fence wire of a metal or a composite metal material and different diameters can be used. For the duct tape, possible substitutes include other colors, and other materials such as masking tape, clear packaging tape, or heavy-duty binding tape. The garbage bag material can be any size or shape or any kind of convenience bag or recycled plastic material. While larger sheet sizes are preferable, any size or any soft, flexible plastic material in sheet form can be used.

Process steps are specified for hand assembly; they can be adapted for machine assembly or various industrial processes. Also, individual process steps can be modified, especially in terms of the leaf structure and number and placement of rings in the flower bloom structure. For instance, the leaf structure may be made without either the chenille pipe cleaner or chenille furry fabric covering the exposed wires. Different methods and different materials can be used for connecting leaves, flower blooms, and other items to the stem backbone. The connection means are not limited to the means specified in the various process steps for the different subassemblies (that is, the leaf structure, flower bloom, and stem backbone). For instance, various epoxies, adhesives, mechanical fasteners, and even velcro can be used as connection means.

Geometric dimensions of materials such as diameter, length, width, thickness, and height are given in general terms. The process steps can be easily modified for different geometries of individual materials. Increases and/or decreases in specific geometric values can be made and the changes lie within the scope of the invention. That is, no particular geometric value is meant to limit the scope of the invention.

Because of the individual and blended characteristics, the artificial floral assembly is ideally suited for many different uses in a home, business, apartment building foyer, photographic studio, window display, promotional displays, concerts, nightclubs, stages, special events, and holidays. This list is by no means meant to be inclusive. When the flowers are painted with UV paint, black lights can be used to create special dramatic effects. It is possible to anchor the flower and/or stem on a wall, floor, or another kind of housing structure. In addition, the artificial floral decoration can lend itself to a parasol configuration, a hanging/mounted wall decoration, a chain linking to create a flower string or artificial garland (using the stem interface).

The overall structure can involve many optional modifications, including the following: (1) Beading on flowers—along edges, hand beaded; (2) LED lights or electro-luminescent wire along petals or in center of flower bloom; (3) Lamp shade, that is, positioning the flower bloom structure with petals surrounding it as shade for light fixture, as long as the light bulb is flourescent, LED, or other suitable material; (4) Screen/folding partition composed of a wall of flowers.

In summary, the overall artificial floral assembly can fit wherever artificial flowers, artificial trees, and other decorative items are used. However, the artificial floral assembly cannot be damaged like other typical artificial flowers or typical natural flowers or plants. A multitude of configurations, with many different textures, sizes, and shapes, can be created.

What is claimed is:

1. (canceled)

2. (canceled)

3. (canceled)

4. An artificial floral assembly comprising
(a) a flower bloom comprising a plurality of loops of wire, the wire loops joined together at a center point, strands of wire dangling from the center point, and fabric covering the wire loops, and
(b) a leaf structure comprising fabric, adhesive material, and wires, the wires connected to the center point of the flower bloom.

5. An artificial floral assembly comprising
(a) a flower bloom comprising a plurality of loops of wire, a center point of the wire loops, strands of wire dangling from the center point, fabric covering the wire loops, and a knot of fabric in the center point,
(b) a leaf structure comprising fabric, adhesive material, and wires, the wires twisted together, and the twisted wires connected to the center point of the flower bloom, and
(c) a stem backbone comprising wire, plastic material, tape, adhesive material, and fabric, the stem interface connected to the twisted wires of the leaf structure, and the stem interface connected to the wire strands dangling from the center point of the flower bloom.

6. An artificial floral assembly as in claim 5 wherein the fabric of the flower bloom comprises footsox material and the fabric of the stem backbone comprises chenille fabric.

7. An artificial floral assembly as in claim 5, wherein the stem backbone is connected to a stein interface, the stem interface comprising a cylinder of pole material and a base, the cylinder further comprising two ends, each end providing a connector opening, and the base further comprising a plurality of legs and a top opening.

8. (canceled)

9. (canceled)

10. (canceled)

11. A process for producing an artificial floral assembly, the process steps comprising
(a) making a leaf structure, the steps of making the leaf structure comprising
1. creating a wire frame of two pieces of wire,
2. cutting a strip of a first fabric, comprising a first section and a second section,
3. streaming adhesive material onto the first section of the first fabric,
4. aligning the wire frames along the first section of the first fabric,
5. folding the second section of the first fabric over the first section of the first fabric,
6. letting the first fabric set for 1 to 24 hours, and
7. cutting the first fabric into shapes of leaves with exposed wires;
(b) making a leaf subassembly, the steps of making the leaf subassembly comprising
1. taking a plurality of leaves with exposed wire and twisting sections of exposed wire,
2. wrapping a second fabric around twisted sections of exposed wire,
3. spreading the adhesive material over the second fabric covering twisted sections of exposed wire,
4. wrapping a third fabric over the adhesive material, and
5. letting the leaf structure set for 1 to 24 hours;
(c) making a flower bloom, the steps of making the flower bloom comprising
1. forming a plurality of rings of wire, with a center point connecting the rings, and with dangling wire strands falling below the center point,
2. separating the plurality of rings of wire so that each of the wire rings is positioned around the center point,
3. covering each of the wire rings with a fourth fabric, the fourth fabric having an end area,
4. connecting the end areas of the fourth fabric covering each of the wire rings, and
5. printing the fourth fabric; and
(d) making a stem backbone, the steps comprising
1. cutting wire into segments, the segments comprising many locations,
2. wrapping a flower bloom around one location of the wire segment,
3. wrapping a leaf around a second location of the wire segment,
4. wrapping plastic material around the wire segment,
5. wrapping tape around the plastic material covering the wire segment,
6. placing the adhesive material over the tape along the wire segment,
7. wrapping a fifth fabric over the adhesive material, and
8. letting the wire segment set for 1 to 24 hours.

12. A process as in claim 11, wherein the adhesive material is caulking.

13. A process as in claim 11, wherein the tape is a duct tape.

14. A process as in claim 11, wherein the fourth fabric covering the wire rings is a footsox material.

15. A process for making a stem backbone of an artificial floral assembly, the process steps comprising
1. cutting wire into segments, the segments comprising many locations,
2. wrapping a flower bloom around one location of the wire segment,
3. wrapping a leaf around a second location of the wire segment,
4. wrapping plastic material around the wire segment,
5. wrapping tape around the plastic material covering the wire segment,
6. placing adhesive material over the tape along the wire segment,
7. wrapping fabric over the adhesive material, and
8. letting the wire segment set for 1 to 24 hours.

16. A process as in claim 15, wherein the adhesive material is caulking.

17. A process as in claim 15, wherein the tape is a duct tape.

18. A process for making a flower bloom of an artificial floral assembly, the process steps comprising
1. forming a plurality of rings of wire, with a center point connecting the rings, and with dangling wire strands falling below the center point,
2. separating the plurality of rings of wire so that each of the wire rings is positioned around the center point,
3. covering each of the wire rings with fabric, the fabric having an end area,
4. connecting the end areas of the fabric covering each of the wire rings, and
5. painting the fabric.

19. A process as in claim 18, wherein the fabric covering the wires is a footsox material.

20. A process as in claim 18, wherein the plurality of rings of wire is formed by
1. taking a plurality of loops of wire, with ends of wire sticking out from the loops,
2. forming a ring of loops of wire, with dangling wire strands falling below a center point,
3. repeating steps at least twice so that there are a plurality of rings, each containing a plurality of wire strands dangling, and
4. connecting the plurality of rings by wrapping the ends of the wire strands together tightly in the center point, with the dangling wire strands hanging freely below the center point.

21. An artificial floral assembly comprising
(a) a stem backbone comprising wire, plastic material covering the wire, duct tape, caulking, and chenille fabric, and
(b) an artificial flower bloom comprising a plurality of loops of wire, the wire loops joined together at a center point, fabric covering the wire loops, and strands of wire dangling from the center point, the dangling wire strands connected to the stem backbone.

22. An artificial floral assembly as in claim 4 further comprising
(a) a stem backbone comprising wire, caulking, plastic material wrapped around the wire, duct tape, and chenille fabric,
(b) means for connecting the stem backbone to the strand of wire of the flower bloom, and
(c) means for connecting the stem backbone to the twisted wires of the leaf.

23. An artificial floral assembly as in claim 22 wherein the stem backbone is connected to a stem interface, the stem interface comprising a cylinder of pole material and a base, the cylinder further comprising two ends, each end providing a connector opening, and the base further comprising a plurality of legs and a top opening.

24. An artificial floral assembly as in claim 4 further comprising a light fixture attached to the flower bloom.

25. An artificial floral assembly as in claim 24 wherein the light fixture is attached to the center point of the flower bloom.

26. An artificial floral assembly as in claim 4 further comprising a multitude of flower blooms of varying dimensions.

27. An artificial floral assembly comprising a stem backbone comprising wire, plastic material covering the wire, duct tape covering the plastic material, caulking covering the duct tape, and chenille fabric covering the caulking.

28. An artificial floral assembly as in claim 27 further comprising a flower bloom comprising
(a) a plurality of loops of wire,
(b) the wire loops joined together at a center point,
(c) fabric covering the wire loops, and
(d) strands of wire dangling from the center point, the strands of wire attached to the stem backbone.

29. An artificial floral assembly as in claim 27 further comprising a leaf structure comprising fabric, adhesive material, and wires, the wires connected to the stem backbone.
